(19) United States
(12) Patent Application Publication
(10) Pub. No.: US 2005/0021448 A1
(43) Pub. Date: Jan. 27, 2005

(54) Commodity trading management device

(75) Inventors: Yasuo Shibusawa, Nagano-ken (JP); Junji Suzuki, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/863,509

(22) Filed: Jun. 9, 2004

(30) Foreign Application Priority Data
Jun. 13, 2003 (JP) 2003-169841

(51) Int. Cl. G06F 17/60

(52) U.S. Cl. 705/37; 705/27; 705/14

(57) ABSTRACT

In response to the user's click of a ‘Checkout Process’ button on an ordered commodity check window, a commodity trading management server of the invention reads cookie files stored in a client terminal and specifies the number of points currently possessed by the user of the client terminal (steps S100 to S120). When the specified number of points reaches a preset number of points, in response to the user's requirement for application of a discount service on a discount service application window, the commodity trading management server applies a discount service and instructs the client terminal to delete the stored cookie files (steps S130 and S170 to S200). On completion of final purchase procedure on a checkout process window, the commodity trading management server sets the number of points to be given to the user this time and instructs the client terminal to generate cookie files corresponding to the setting number of points (steps S150 and S160).

### BACKGROUND OF THE INVENTION

1. Field of the Invention

The present invention relates to a commodity trading management device. Specifically, the invention relates to a commodity trading management device that manages information on trading of commodities with multiple client devices connected via a communication line.

2. Description of the Prior Art

A proposed commodity trading management device provides an online shopping site on the Internet, gives service points to respective users who have purchased commodities at the online shopping site, and manages the service points given to the users (see, for example, Japanese Patent Laid-Open Gazette No. 2002-269368). This prior art device utilizes a database established on a server and consolidates management of the service points given to the respective users.

This prior art device utilizing the database on the server for management of the service points requires adequate operation and management of the server and the database. Expansion of the commodity trading management system significantly increases the load applied on the server to lower the processing speed and raises the required storage capacity. The number of users who participate in the commodity trading management system is expected to increase with the growing rate of the Internet access.

### SUMMARY OF THE INVENTION

The object of the present invention is to attain simple management of service points given to users of an online shopping. The object of the invention is also to relieves the load of the server computer effectively.

In order to achieve at least part of aforementioned objects, the present invention is constructed as follows.

A first commodity trading management device of the present invention is a device that manages information on trading of commodities with multiple client devices connected via a communication line, the commodity trading management device including: a data storage module that stores data; a data reception transmission module that is capable of receiving and transmitting data from and to each of the multiple client devices; an order acceptance control module including an order data reception control sub-module, a point data generation sub-module, and a point data transmission control sub-module, the order data reception control sub-module controlling the data reception transmission module to receive order data regarding an order of a commodity sent from one of the multiple client devices and storing the received order data into the data storage module, the point data generation sub-module reading the order data out of the data storage module in the course of execution of a series of order acceptance process relating to acceptance of the order corresponding to the order data and generating point data regarding a point to be given to a user of the client device based on the read-out order data, the point data transmission control sub-module controlling the data reception transmission module to send the generated point data to the client device in a storable manner; and a service processing control module that controls the data reception transmission module to receive the point data stored in the client device in response to a predetermined request and executes a preset service based on the received point data.

The first commodity trading management device constructed as above receives order data of a commodity sent from one of multiple client devices, stores the received order data into the data storage module, generates the point data regarding a point to be given to the user of the client device, based on the order data in the course of execution of a series of order acceptance process with regard to the stored order data, sends the generated point data to the client device, receives the point data stored in the client device in response to a predetermined request, and executes a preset service based on the received point data. Namely the commodity trading management device generates the point data based on the order data of the commodity, sends the generated point data to the client device, and executes the preset service based on the transmitted point data. This arrangement attains simple management of the points given to the user of the client and effectively relieves the load of the computer (server). Here the ‘series of order acceptance process’ includes diversity of processes relating to acceptance of orders in trading of commodities with multiple client devices connected via a communication line. The diversity of processes include, for example, a process of calculating a sum total of selected commodities in an order and a process of sending window data of a window to ask the user to enter required pieces of information (for example, the method of payment) for final purchase procedure to the client device. The first commodity trading management device may be a computer system with multiple computers.

In one preferable embodiment, the commodity trading management device of the invention functions as a Web server, and the point data transmission control sub-module of the order acceptance control module sends the point data as data of at least part of cookie files stored in the client device.

In another preferable embodiment of the commodity trading management device of the invention, the data storage module stores at least commodity identification information for identifying each commodity and price of each commodity as commodity data relating to commodities, the order data includes commodity identification information on a commodity to be ordered and an order quantity, and the point data generation sub-module of the order acceptance control module generates the point data, based on the price of the commodity stored in the data storage module, which corresponds to the commodity identification information of the order data, and the order quantity of the order data.

In another preferable embodiment of the commodity trading management device of the invention, the point data generation sub-module of the order acceptance control module generates the point data on completion of an order confirmation step in the series of order acceptance process.

In still another preferable embodiment of the commodity trading management device of the invention, the point data includes at least a number of points, and the service processing control module executes the preset service, based on the number of points included in the received point data. As one structure of this embodiment, the point data transmission control sub-module of the order acceptance control module may control the data reception transmission module to send a certain number of preset electronic files corresponding to the number of points as the point data to the client device in a storable manner, and the service processing control module may control the data reception transmission module to receive the preset electronic files stored in the client device and execute the preset service based on number of the received preset electronic files. As another structure of the above embodiment, the point data transmission control sub-module of the order acceptance control module may control the data reception transmission module to send the certain number of preset electronic files to be stored in a preset area in a storage medium of the client device, and the service processing control module may control the data reception transmission module to receive the preset electronic files stored in the preset area in the storage medium of the client device and execute the preset service based on number of the received preset electronic files.

In the commodity trading management device of the invention, the preset service may be a discount service to discount price of each commodity, and the service processing control module may control the data reception transmission module to receive the point data stored in the client device in the course of the series of order acceptance process, and execute the discount service based on the received point data. The preset service may be a gift presentation service to present a gift, and the service processing control module may control the data reception transmission module to receive the point data stored in the client device, in response to a request for execution of the gift presentation service sent from the client device, and execute the gift presentation service based on the received point data.

In still another preferable embodiment of the commodity trading management device of the invention, the service processing control module determines whether execution of the preset service is allowed or not allowed, based on the received point data, and when it is determined that execution of the preset service is allowed, controls the data reception transmission module to send window data of a window to ask the user to enter requirement or non-requirement of execution of the preset service, to the client device.

In still another preferable embodiment of the commodity trading management device of the invention, the service processing control module executes the preset service and controls the data reception transmission module to send a request for deletion of the point data stored in the client device, to the client device.

A storage medium of the present invention of is a storage medium in which a commodity trading management device program is stored, the program causing a computer, which includes a data storage module that stores data and a data reception transmission module that is capable of receiving and transmitting data from and to each of multiple client devices, to function as a commodity trading management device that manages information on trading of commodities with the multiple client devices connected via a communication line, the commodity trading management device program stored in the storage medium including: an order data reception module that controls the data reception transmission module to receive order data regarding an order of a commodity sent from one of the multiple client devices and stores the received order data into the data storage module; a point data generation module that reads the order data out of the data storage module in the course of execution of a series of order acceptance process relating to acceptance of the order corresponding to the order data, and generates point data regarding a point to be given to a user of the client device based on the read-out order data; a point data transmission control module that controls the data reception transmission module to send the generated point data to the client device in a storable manner; and a service processing control module that controls the data reception transmission module to receive the point data stored in the client device in response to a predetermined request and executes a preset service based on the received point data.

The commodity trading management device program stored in the storage medium of the invention is installed in the computer. The computer thus functions as the commodity trading management device that receives order data of a commodity sent from one of multiple client devices, stores the received order data into the data storage module, generates the point data regarding a point to be given to the user of the client device, based on the order data in the course of execution of a series of order acceptance process with regard to the stored order data, sends the generated point data to the client device, receives the point data stored in the client device in response to a predetermined request, and executes a preset service based on the received point data. Namely the commodity trading management device program generates the point data based on the order data of the commodity, sends the generated point data to the client device, and executes the preset service based on the transmitted point data. This arrangement attains simple management of the points given to the user of the client and effectively relieves the load of the computer (server). Here the ‘series of order acceptance process’ includes diversity of processes relating to acceptance of orders in trading of commodities with multiple client devices connected via a communication line. The diversity of processes include, for example, a process of calculating a sum total of selected commodities in an order and a process of sending window data of a window to ask the user to enter required pieces of information (for example, the method of payment) for final purchase procedure to the client device. The commodity trading management device program stored in the storage medium of the invention may cause a computer system including multiple computers to function as the commodity trading management device.

A second commodity trading management device of the present invention is a device that manages information on trading of commodities with multiple client devices connected via a communication line, the commodity trading management device including: a data storage module that stores data; a data reception transmission module that is capable of receiving and transmitting data from and to each of the multiple client devices; and a control module including an order data reception control sub-module, a point data generation sub-module, and a point data transmission control sub-module, the order data reception control sub-module controlling the data reception transmission module to receive order data regarding an order of a commodity sent from one of the multiple client devices and storing the received order data into the data storage module, the point data generation sub-module reading the order data out of the data storage module in the course of execution of a series of order acceptance process relating to acceptance of the order corresponding to the order data and generating point data regarding a point to be given to a user of the client device based on the read-out order data, the point data transmission control sub-module controlling the data reception transmission module to send the generated point data to the client device in a storable manner.

The second commodity trading management device of the invention receives order data of a commodity sent from one of multiple client devices, stores the received order data into the data storage module, generates the point data regarding a point to be given to the user of the client device, based on the order data in the course of execution of a series of order acceptance process with regard to the stored order data, and sends the generated point data to the client device. Namely the second commodity trading management device generates the point data based on the order data of the commodity and sends the generated point data to the client device. A device that provides a service based on the point data can thus effectively utilize the point data. Here the ‘series of order acceptance process’ includes diversity of processes relating to acceptance of orders in trading of commodities with multiple client devices connected via a communication line. The diversity of processes include, for example, a process of calculating a sum total of selected commodities in an order and a process of sending window data of a window to ask the user to enter required pieces of information (for example, the method of payment) for final purchase procedure to the client device. The second commodity trading management device may be a computer system with multiple computers.

### BRIEF DESCRIPTION OF THE DRAWINGS

FIG. 1 schematically illustrates the configuration of a system including a commodity trading management server 20;

FIG. 2 shows one example of information managed in a commodity table 30a;

FIG. 3 is a flowchart showing an order acceptance processing routine;

FIG. 4 shows one example of a commodity display window 70;

FIG. 5 shows one example of a ordered commodity check window 72;

FIG. 6 shows one example of a checkout process window 74;

FIG. 7 shows mapping of sum total of commodities to number of points;

FIG. 8 shows one example of a discount service application window 76; and

FIG. 9 shows one example of a discount checkout window 78.

### DESCRIPTION OF THE PREFERRED EMBODIMENTS

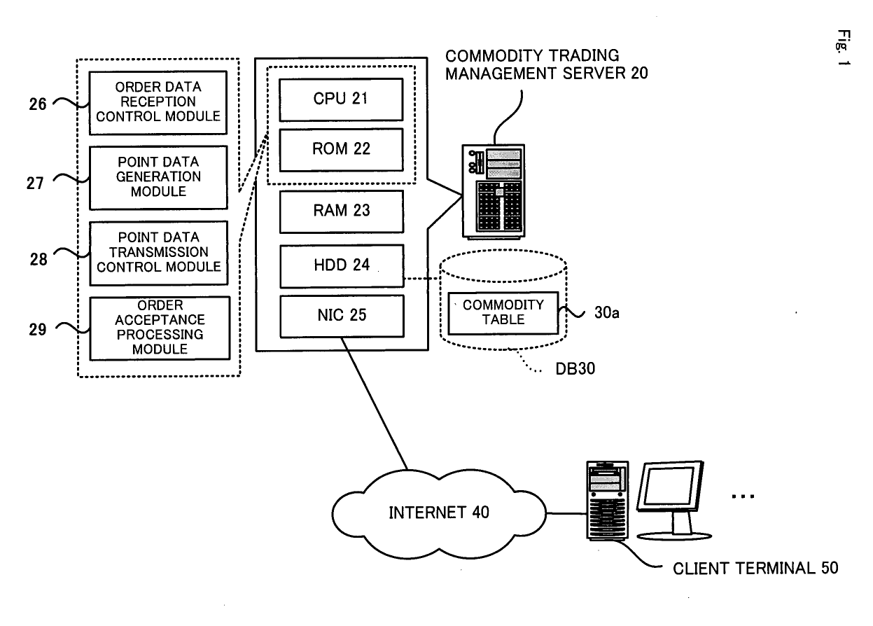

One preferred embodiment of the invention is discussed below. FIG. 1 schematically illustrates the configuration of a system including a commodity trading management server 20, which functions as a commodity trading management device in one embodiment of the invention. As illustrated, the commodity trading management server 20 of the embodiment is constructed as a general-purpose computer including a CPU 21, a ROM 22, and a RAM 23 and additionally has a hard disk drive (HDD) 24 for storing a diversity of data and a network interface card (NIC) 25 for connection to a network. The commodity trading management server 20 functions as a Web server that sends Web pages in response to a request from a client terminal 50 connected via the Internet 40, and provides a commodity trading site to the client terminal 50. The HDD 24 stores HTML files and image files, which are used to construct Web pages on the commodity trading site, and diverse programs. A database 30 as a general DBMS (database management system) is installed in the HDD 24. The database 30 includes a commodity table 30a for management of commodity-relating information. The commodity trading management server 20 also has an order data reception control module 26 that receives commodity order-relating data from the client terminal 50, a point data generation module 27 that generates point data based on the commodity order-relating data, a point data transmission control module 28 that transmits the generated point data, and an order acceptance processing module 29 that executes a series of processing from an order of commodities to a purchase procedure. These modules of the commodity trading management server 20 attain the respective steps of an order acceptance processing routine discussed later. The order data reception control module 26, the point data generation module 27, the point data transmission control module 28, and the order acceptance processing module 29 shown as functional blocks are actualized by the combined functions of the CPU 21, the ROM 22, and diverse programs stored in the HDD 24.

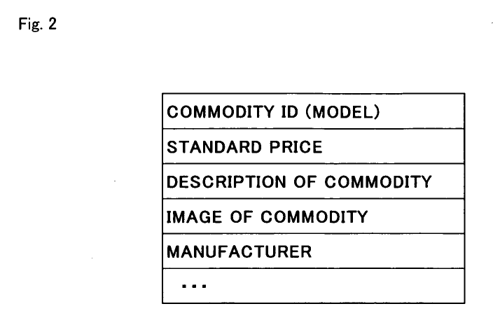

FIG. 2 shows one example of the information managed in the commodity table 30a of the database 30. The commodity table 30a is designed to manage information including an ID for identifying each commodity (commodity ID), as well as the standard price, description, image data, and manufacturer of the commodity, as shown in FIG. 2.

The client terminal 50 is constructed as a general-purpose computer including a CPU, memories, and a hard disk drive (not shown), and a Web browser is installed in the client terminal 50 to display Web pages. Multiple client terminals 50 and other client devices having equivalent functions to those of the client terminals 50 (for example, cell phones, personal digital assistants, and home video game machines) may be connected to the Internet 40.

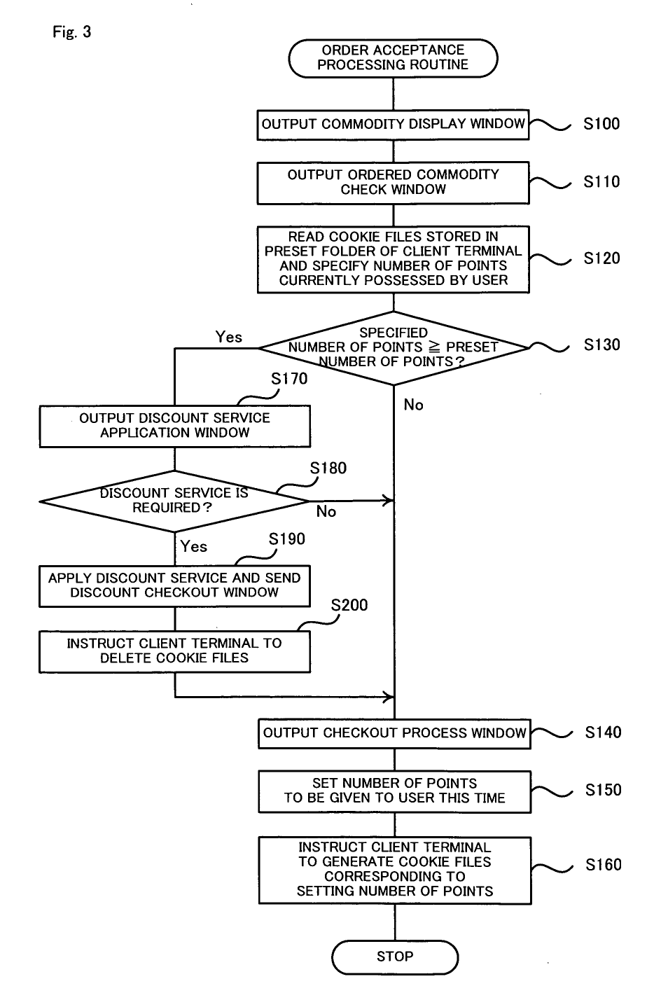

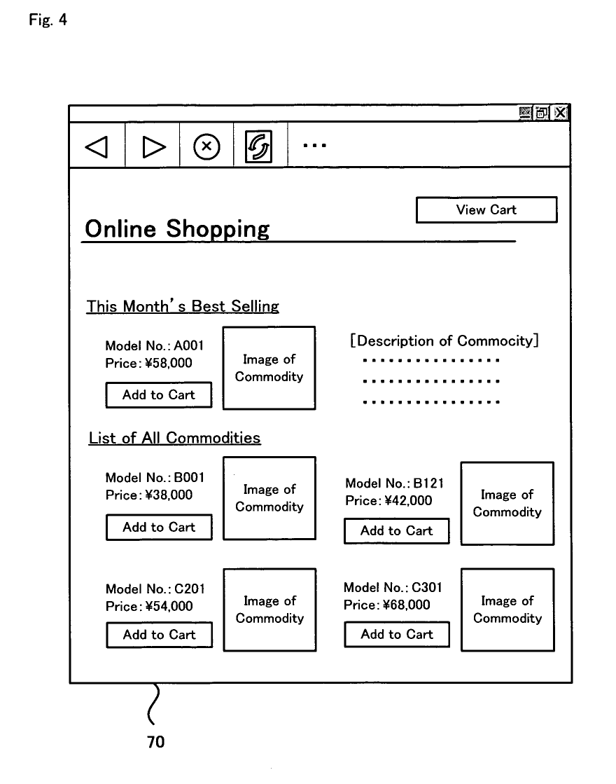

The following describes the operations of the commodity trading management server 20 constructed as discussed above. FIG. 3 is a flowchart showing an order acceptance processing, routine, which is executed by the commodity trading management server 20 when the client terminal 50 sends data representing a request for an access to a top page of the commodity trading site. When the order acceptance processing routine starts, the commodity trading management server 20 first sends window data of a commodity display window 70 as a top page showing commodity-relating data to the client terminal 50 (step S100) FIG. 4 shows one example of the commodity display window 70. In the illustrated example, the commodity display window 70 is designed to display information like model numbers and prices as the commodity-relating data. These pieces of information are read from the commodity table 30a in the database 30. In response to the user's click of an ‘Add to Cart’ button to order each selected commodity on the commodity display window 70, information on selected commodities in an order is written into cookie files in the client terminal 50. Here the cookie files are text files generally used for transmission of information between a Web server and a Web browser, and are stored in a predetermined folder (for example, ‘C: ¥ . . . ¥Cookies’) in the client terminal 50, where the Web browser is installed.

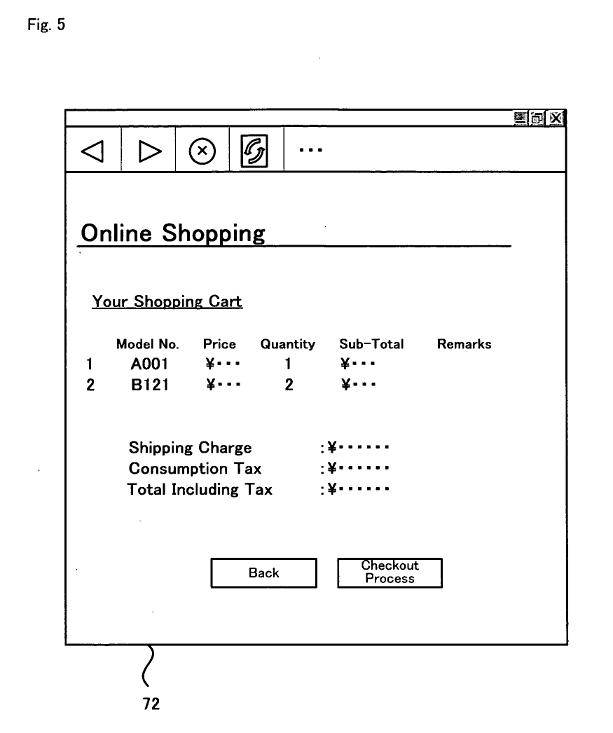

In response to the user's click of a ‘View Cart’ button on the commodity display window 70, the commodity trading management server 20 sends window data of an ordered commodity check window 72 to show the information on the selected commodities in the order to the client terminal 50 (step S110). FIG. 5 shows one example of the ordered commodity check window 72. In the illustrated example, the ordered commodity check window 72 is designed to display the information on the selected commodities in the order and a sum total including a shipping charge and a consumption tax. As mentioned above, the information on the selected commodities in the order is written into cookie files in the client terminal 50. The procedure thus reads related cookie files from the predetermined folder in the client terminal 50, gains the information on the selected commodities in the order, and sends the window data of the ordered commodity check window 72.

In response to the user's click of a ‘Checkout Process’ button on the ordered commodity check window 72, the commodity trading management server 20 reads cookie files in the client terminal 50 to specify the number of points currently possessed by the user of the client terminal 50 (step S120) and determines whether the specified number of points reaches a preset number of points (for example, 10 points) for discount service (step S130). The point management method utilizing cookie files in the client terminal 50 will be discussed later.

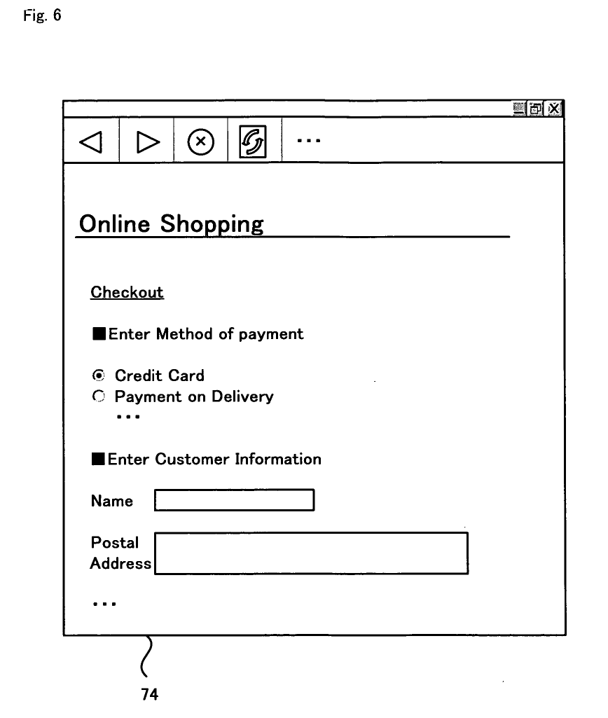

When the result of the determination at step S130 shows that the number of points currently possessed by the user of the client terminal 50 does not reach the preset number of points, the commodity trading management server 20 sends window data of a checkout process window 74 for the final purchase procedure to the client terminal 50 (step S140). FIG. 6 shows one example of the checkout process window 74. In the illustrated example, the checkout process window 74 is designed to ask the user to enter required pieces of information for the final purchase procedure including the method of payment and the user-relating information.

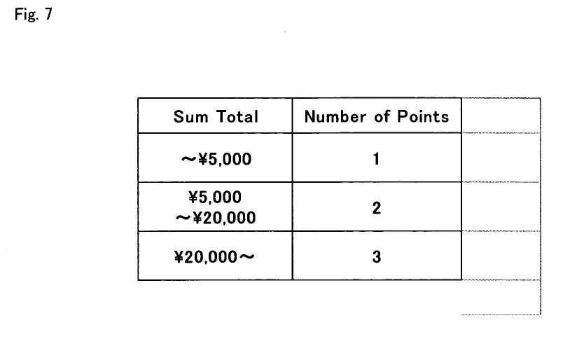

When the user enters the required pieces of information on the checkout process window 74 to complete the final purchase procedure, the commodity trading management server 20 sets a number of points to be given to the user of the client terminal 50 this time (step S150) and instructs the client terminal 50 to generate cookie files corresponding to the setting number of points (step S160). The order acceptance processing routine is then terminated. The procedure of the embodiment specifies in advance a mapping of the sum total of the ordered commodities to the number of points to be given, stores the specified mapping in the database 30 or the like, and reads the number of points to be given to the user corresponding to the sum total of the commodities subjected to the purchase procedure. FIG. 7 shows one example of the mapping of the sum total of commodities to the number of points to be given. In the illustrated example, the number of points to be given increases with an increase in sum total of commodities. The procedure of step S160 in the embodiment instructs the client terminal 50 to generate one cookie file (hereafter referred to as point cookie file) to each point and thereby generate point cookie files corresponding to the setting number of points. Identification data to identify point-relating data regarding points given by the commodity trading site of the commodity trading management server 20 is written into each point cookie file. The procedure of step S120 in the embodiment reads point cookie files from a preset folder in the client terminal 50 and counts the number of point cookie files to specify the number of points currently possessed by the user of the client terminal 50.

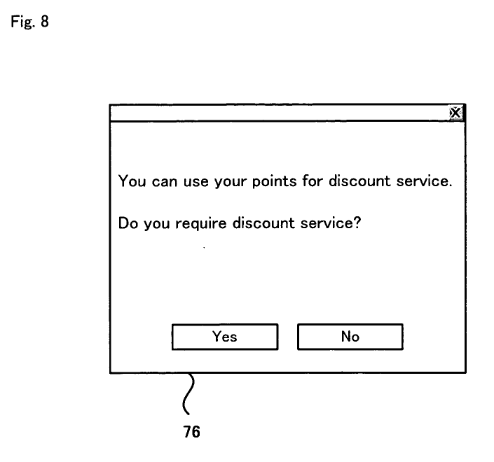

When the result of the determination at step S130 shows that the number of points currently possessed by the user of the client terminal 50 reaches the preset number of points, on the other hand, the commodity trading management server 20 sends window data of a discount service application window 76 to ask the user whether to require a commodity discount service to the client terminal 50 (step S170). One example of the discount service application window 76 shown in FIG. 8 is designed to ask the user to select either a ‘Yes’ button or a ‘No’ button and thereby enter requirement or non-requirement of the discount service.

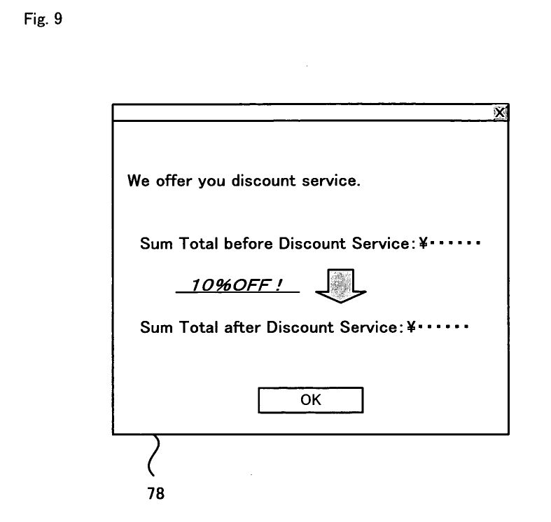

In response to the user's entry of non-requirement of the discount service on the discount service application window 76 (that is, in response to the user's click of the ‘No’ button) (step S180), the commodity trading management server 20 proceeds to step S140 to output the checkout process window 74, to step S150 to set the number of points to be given to the user this time, and to step S160 to give an instruction of generating point cookie files corresponding to the setting number of point and then terminates the order acceptance processing routine. In response to the user's entry of requirement of the discount service on the discount service application window 76 (that is, in response to the user's click of the ‘Yes’ button) (step S180), on the contrary, the commodity trading management server 20 discounts the standard prices of the respective ordered commodities by a preset discount rate (for example, 10%) and sends window data of a discount checkout window 78 to display the sum total of the commodities after the discount to the client terminal 50 (step S190). One example of the discount checkout window 78 shown in FIG. 9 is designed to display the sum total before the discount service and the sum total after the discount service.

After the processing of the discount service, the commodity trading management server 20 instructs the client terminal 50 to delete the point cookie files involved in the discount service (step S200), outputs the checkout process window 74 (step S140), sets the number of points to be given to the user this time (step S150), gives an instruction of generating point cookie files corresponding to the setting number of points (step S160), and terminates the order acceptance processing routine. In the case of application of the discount service, the procedure may omit the step of setting the number of points to be given to the user this time and the step of generating point cookie files corresponding to the setting number of points.

As described above, the commodity trading management server 20 of the embodiment sets the number of points to be given to the user this time, based on the sum total of the commodities ordered by the user of the client terminal 50 and subjected to the purchase procedure. The commodity trading management server 20 then gives an instruction of generating point cookie files corresponding to the setting number of points and stores the generated point cookie files into a preset folder in the client terminal 50. In the purchase procedure on the checkout process window 74, the commodity trading management server 20 reads the point cookie files from the preset folder in the client terminal 50 and specifies the number of points currently possessed by the user of the client terminal 50. When the specified number of points reaches the preset number of points, the user can receive the discount service of the commodities. This arrangement manages the number of points given to the user of each client terminal 50 by simple use of cookie files and relieves the load of the commodity trading management server 20.

In the commodity trading management server 20 of the embodiment, the ROM 22, the RAM 23, and the HDD 24 correspond to a data storage module of the invention, the NIC 25 corresponds to a data reception transmission module of the invention, and the CPU 21 that executes the order acceptance processing corresponds to an order acceptance control module and a service processing control module of the invention.

The commodity trading management server 20 of the embodiment sets the number of points corresponding to the sum total of the commodities subjected to the purchase procedure. One possible modification may set the number of points, based on another piece of information regarding the order of commodities, for example, based on the model numbers of the commodities subjected to the purchase procedure. Another possible modification may set one point to each trade (order), regardless of the sum total of the commodities in the order.

When the final purchase procedure is completed on the checkout process window 74, the commodity trading management server 20 of the embodiment sets the number of points to be given to the user of the client terminal 50 this time and instructs the client terminal 50 to generate point cookie files corresponding to the setting number of points. The process of setting the number of points and giving an instruction of generating point cookie files may be executed at another timing, for example, in response to the user's click of the ‘Checkout Process’ button on the ordered commodity check window 72. For cancellation of the purchase procedure, the commodity trading management server 20 sends an instruction of deleting the generated point cookie files to the client terminal 50 according to the requirements.

The commodity trading management server 20 of the embodiment instructs the client terminal 50 to generate one point cookie file corresponding to one point. It is, however, not necessary to manage the number of points by the number of point cookie files. One modified procedure may write a value representing the number of points as one of data into a point cookie file. In the case where the specification of the Web browser allows for only one cookie file, the procedure may generate one record corresponding to one point in the cookie file. The information regarding the points to be given to the user is not restricted to the number of points but may be the sum total of trading. The discount service may be offered according to the sum total of trading.

In response to the user's click of the ‘Checkout Process’ button on the ordered commodity check window 72, the commodity trading management server 20 of the embodiment reads the point cookie files from the preset folder in the client terminal 50 and specifies the number of points currently possessed by the user of the client terminal 50. When the specified number of points reaches the preset number of points, the order acceptance processing routine executes the processing of the discount service at steps S170 to S200. The processing of the discount service according to the number of points may be executed at another timing. For example, the processing of the discount service according to the number of points may be executed at a first step in the order acceptance processing routine. In this case, the procedure may display prices of the respective commodities after discount on the commodity display window 70 as the top page.

When the number of points currently possessed by the user of the client terminal 50 reaches the preset number of points, the commodity trading management server 20 of the embodiment sends the window data of the discount service application window 76 to the client terminal 50. One possible modification may not send the window data of the discount service application window 76. Namely the discount service may automatically be offered to the user, when the number of points currently possessed by the user of the client terminal 50 reaches the preset number of points.

The commodity trading management server 20 of the embodiment offers the discount service of the commodities, when the number of points currently possessed by the user of the client terminal 50 reaches the preset number of points. One possible modification may offer different discount services according to the number of points. For example, the discount rate of the discount service may be raised with an increase in number of points. The discount service is not restrictive at all, and any other service may be offered to the user of the client terminal 50. One example presents some gift to the user when the number of points currently possessed by the user reaches the preset number of points.

The commodity trading management server 20 of the embodiment instructs the client terminal 50 to delete the point cookie files involved in the discount service, after the processing of the discount service is completed. The instruction of such deletion may be omitted, according to the requirements.

The commodity trading management server 20 of the embodiment functions as the Web server. The Web technology is, however, not essential for this invention. The required technique is to process, receive, and send data in response to requests from a client device and thereby accomplish the procedure for trading of commodities. The use of cookie files is also not essential. One applicable method may send and store electronic files corresponding to point cookie files to and into a preset folder in a storage medium of the client device.

The commodity trading management server 20 of the embodiment executes the processing of the discount service at steps S170 to S200, when the number of points currently possessed by the user of the client terminal 50 reaches the preset number of points. One possible modification may not offer a discount service according to the number of points but may simply give points (set the number of points to be given to the user and give an instruction of generating cookie files). In this case, in response to the user's click of the ‘Checkout Process’ button on the ordered commodity check window 72, the order acceptance processing routine of FIG. 3 may immediately proceed to step S140 to output the checkout process window 74.

The commodity trading management server 20 of the embodiment is constructed as the general-purpose computer including the CPU 21, the ROM 22, and the RAM 23. The hardware configuration is, however, not restricted to this embodiment. The commodity trading management server 20 of the embodiment may be constructed by multiple general-purpose computers.

In the above embodiment, the technique of the present invention is applied to the commodity trading management server 20. The technique of the invention is also applicable to a corresponding method. Still another application is a program that causes one or multiple computers to function as the commodity trading management server 20 of the embodiment. In the case of such programs, the respective steps of order acceptance processing routine shown in FIG. 3 maybe programmed in a suitable programming language.

The above embodiment is to be considered in all aspects as illustrative and not restrictive. There may be many modifications, changes, and alterations without departing from the scope or spirit of the main characteristics of the present invention. All changes within the meaning and range of equivalency of the claims are therefore intended to be embraced therein.

1. A commodity trading management device that manages information on trading of commodities with multiple client devices connected via a communication line, said commodity trading management device comprising:
a data storage module that stores data;
a data reception transmission module that is capable of receiving and transmitting data from and to each of the multiple client devices;
an order acceptance control module comprising an order data reception control sub-module, a point data generation sub-module, and a point data transmission control sub-module, said order data reception control sub-module controlling said data reception transmission module to receive order data regarding an order of a commodity sent from one of the multiple client devices and storing the received order data into said data storage module, said point data generation sub-module reading the order data out of said data storage module in the course of execution of a series of order acceptance process relating to acceptance of the order corresponding to the order data and generating point data regarding a point to be given to a user of the client device based on the read-out order data, said point data transmission control sub-module controlling said data reception transmission module to send the generated point data to the client device in a storable manner; and
a service processing control module that controls said data reception transmission module to receive the point data stored in the client device in response to a predetermined request and executes a preset service based on the received point data.

2. A commodity trading management device in accordance with claim 1, said commodity trading management device functioning as a Web server,
wherein said point data transmission control sub-module of said order acceptance control module sends the point data as data of at least part of cookie files stored in the client device.

3. A commodity trading management device in accordance with claim 1, wherein said data storage module stores at least commodity identification information for identifying each commodity and price of each commodity as commodity data relating to commodities,
the order data includes commodity identification information on a commodity to be ordered and an order quantity, and
said point data generation sub-module of said order acceptance control module generates the point data, based on the price of the commodity stored in said data storage module, which corresponds to the commodity identification information of the order data, and the order quantity of the order data.

4. A commodity trading management device in accordance with claim 1, wherein said point data generation sub-module of said order acceptance control module generates the point data on completion of an order confirmation step in the series of order acceptance process.

5. A commodity trading management device in accordance with claim 1, wherein the point data includes at least a number of points, and
said service processing control module executes the preset service, based on the number of points included in the received point data.

6. A commodity trading management device in accordance with claim 5, wherein said point data transmission control sub-module of said order acceptance control module controls said data reception transmission module to send a certain number of preset electronic files corresponding to the number of points as the point data to the client device in a storable manner, and
said service processing control module controls said data reception transmission module to receive the preset electronic files stored in the client device and executes the preset service based on number of the received preset electronic files.

7. A commodity trading management device in accordance with claim 6, wherein said point data transmission control sub-module of said order acceptance control module controls said data reception transmission module to send the certain number of preset electronic files to be stored in a preset area in a storage medium of the client device, and
said service processing control module controls said data reception transmission module to receive the preset electronic files stored in the preset area in the storage medium of the client device and executes the preset service based on number of the received preset electronic files.

8. A commodity trading management device in accordance with claim 1, wherein the preset service is a discount service to discount price of each commodity, and
said service processing control module controls said data reception transmission module to receive the point data stored in the client device in the course of the series of order acceptance process, and executes the discount service based on the received point data.

9. A commodity trading management device in accordance with claim 1, wherein the preset service is a gift presentation service to present a gift, and
said service processing control module controls said data reception transmission module to receive the point data stored in the client device, in response to a request for execution of the gift presentation service sent from the client device, and executes the gift presentation service based on the received point data.

10. A commodity trading management device in accordance with claim 1, wherein said service processing control module determines whether execution of the preset service is allowed or not allowed, based on the received point data, and when it is determined that execution of the preset service is allowed, controls said data reception transmission module to send window data of a window to ask the user to enter requirement or non-requirement of execution of the preset service, to the client device.

11. A commodity trading management device in accordance with claim 1, wherein said service processing control module executes the preset service and controls said data reception transmission module to send a request for deletion of the point data stored in the client device, to the client device.

12. A storage medium in which a commodity trading management device program is stored, said commodity trading management device program causing a computer, which comprises a data storage module that stores data and a data reception transmission module that is capable of receiving and transmitting data from and to each of multiple client devices, to function as a commodity trading management device that manages information on trading of commodities with the multiple client devices connected via a communication line,
said commodity trading management device program stored in said storage medium comprising:
an order data reception module that controls said data reception transmission module to receive order data regarding an order of a commodity sent from one of the multiple client devices and stores the received order data into said data storage module;
a point data generation module that reads the order data out of said data storage module in the course of execution of a series of order acceptance process relating to acceptance of the order corresponding to the order data, and generates point data regarding a point to be given to a user of the client device based on the read-out order data;
a point data transmission control module that controls said data reception transmission module to send the generated point data to the client device in a storable manner; and
a service processing control module that controls said data reception transmission module to receive the point data stored in the client device in response to a predetermined request and executes a preset service based on the received point data.

13. A commodity trading management device that manages information on trading of commodities with multiple client devices connected via a communication line, said commodity trading management device comprising:
a data storage module that stores data;
a data reception transmission module that is capable of receiving and transmitting data from and to each of the multiple client devices; and
a control module comprising an order data reception control sub-module, a point data generation sub-module, and a point data transmission control sub-module, said order data reception control sub-module controlling said data reception transmission module to receive order data regarding an order of a commodity sent from one of the multiple client devices and storing the received order data into said data storage module, said point data generation sub-module reading the order data out of said data storage module in the course of execution of a series of order acceptance process relating to acceptance of the order corresponding to the order data and generating point data regarding a point to be given to a user of the client device based on the read-out order data, said point data transmission control sub-module controlling said data reception transmission module to send the generated point data to the client device in a storable manner.
